(19) United States
(12) Patent Application Publication
(10) Pub. No.: US 2014/0195137 A1
(43) Pub. Date: Jul. 10, 2014

(54) INTERNAL COMBUSTION ENGINE CONTROL APPARATUS AND INTERNAL COMBUSTION ENGINE CONTROL METHOD

(71) Applicant: Michael Fischer, Offenbach am Main (DE)

(72) Inventor: Michael Fischer, Offenbach am Main (DE)

(73) Assignee: HONDA MOTOR CO., LTD., Tokyo (JP)

(21) Appl. No.: 13/990,876

(22) PCT Filed: Mar. 30, 2012
(86) PCT No.: PCT/JP2012/059433

§ 371 Date: May 31, 2013

(51) Int. Cl. F02D 35/02

(52) U.S. Cl. CPC F02D 35/02
USPC 701/110

(57) ABSTRACT

An internal combustion engine control apparatus, which is for a vehicle which runs on power from an electric motor, derives a required power of the electric motor, derives a power that the electric motor can output by electric power supplied from the battery, derives an optimum power in the generator based on the required power and an attainable power, determines an operation mode of the internal combustion engine based on a magnitude of the optimum generator power, derives an offset value for correcting an operation point of the internal combustion engine when operated in a constant point operation mode, derives, based on the optimum generator power, a target operation point for the internal combustion engine operated in the constant point operation mode, and controls the internal combustion engine to operate at an operation point which is obtained by correcting the target operation point by the offset value.

### TECHNICAL FIELD

The present invention relates to an internal combustion engine control apparatus and an internal combustion engine control method for a hybrid vehicle.

### BACKGROUND ART

HEVs (Hybrid Electric Vehicles) include an electric motor and an internal combustion engine and run on driving force from the motor and/or the internal combustion engine depending upon the running conditions of the vehicle. HEVs are classified roughly into two configurations: a series hybrid configuration and a parallel hybrid configuration. A series HEV runs on driving force from an electric motor which utilizes a battery as a power supply. An internal combustion engine is used only for generating electric power, and electric power generated by the driving force of the internal combustion engine is stored in the battery or is supplied to the electric motor. On the other hand, a parallel HEV runs on driving force from either or both of an electric motor and an internal combustion engine. Additionally, there is known an HEV which utilizes a series-parallel configuration in which the two configurations described above are combined together. In this series-parallel configuration, a clutch is disengaged or engaged (disengaged/engaged) depending upon the running conditions of a vehicle so as to switch the driving force transmission line to either the series hybrid configuration or the parallel hybrid configuration.

The operation of the internal combustion engine in the series HEV is divided roughly into two types: a “constant point operation” and a “power-follow operation.” The “constant point operation” is the operation of the internal combustion engine which is performed mainly when the charging rate of a battery is low. As this occurs, the internal combustion engine is driven at a constant revolution speed at which the fuel consumption per unit generating energy becomes the least. The power generating efficiency by the internal combustion engine becomes the best then. Electric power generated through the constant point operation of the internal combustion engine is stored in the battery.

In addition, the “power-follow operation” is the operation of the internal combustion engine when electric power equivalent to a value that the driver requires (hereinafter, referred to as a “driver requiring value”) as electric power to be supplied to the electric motor which is obtained from a vehicle speed or accelerator pedal opening is supplied to the electric motor not from the battery but through generation of electric power by use of the power of the internal combustion engine. The electric power generated then is not stored in the battery but is consumed by the electric motor. When driven based on the power-follow operation, the internal combustion engine is driven at a revolution speed which is required to supply the electric power equivalent to the driver requiring value. Namely, the revolution speed of the internal combustion engine changes as the driver requiring value changes.

### CITATION LIST

### Patent Literature

PTL1: JP-A-8-151941

### SUMMARY OF INVENTION

### Technical Problem

The electric vehicle disclosed in Patent Literature 1 includes a battery, a generator which charges the battery, an engine which drives the generator, a drive motor which is driven by the battery, vehicle speed detection means which detect a vehicle speed, and control means which decrease the revolution speed of the engine and the power generating rate of the generator when the vehicle speed detected by the vehicle speed detection means are detected as being equal to or slower than a predetermined vehicle speed. According to the electric vehicle, the level of noise and exhaust emission of the engine when the vehicle runs at low speeds or is stopped can be reduced sufficiently, and moreover, the battery can be prevented from becoming flat as a result of idling over a long period of time.

Incidentally, in a conventional vehicle in which an internal combustion engine is mounted as a drive source, when the driver depresses the accelerator pedal, the level of noise of the internal combustion engine changes. In the series HEV described above, however, even when the drive depresses the accelerator pedal while the internal combustion engine id driven based on the constant point operation, the noise level of the internal combustion engine does not change. Although the driving condition of the electric motor changes by the accelerator pedal being depressed, the noise level of the electric motor varies little. Because of this, when drivers drive a series HEV who used to drive a conventional vehicle, some of the drivers may feel a sense of incongruity due to the operation noise from the drive source varying little even in the event that they depress the accelerator pedal of the former vehicle when the internal combustion engine is driven based on the constant point operation.

An object of the invention is to provide an internal combustion engine control apparatus and an internal combustion engine control method for a hybrid vehicle which includes an internal combustion engine provided for electricity generation, which prevent a driver of the hybrid vehicle from feeling a sense of incongruity when the driver performs an accelerating or decelerating operation while the internal combustion engine is driven based on a constant point operation.

### Solution to Problem

With a view to solving the problem to attain the object, according to claim 1 of the invention, there is provided an internal combustion engine control apparatus (for example, a management ECU 119 of an embodiment) for a hybrid vehicle which runs on power from an electric motor (for example, an electric motor 107 of the embodiment) which is driven by at least either of electric power generated in a generator (for example, a generator 111 of the embodiment) by power of an internal combustion engine (for example, an internal combustion engine 109) and electric power supplied from a battery (for example, a battery 101 of the embodiment), including: a required power deriving portion (for example, a required power calculation portion 201 of the embodiment) for deriving a required power which is a power of the electric motor outputted in accordance with an accelerator pedal operation in the hybrid vehicle; an operation mode determination portion (for example, an operation mode determination portion 207 of the embodiment) for determining an operation mode of the internal combustion engine based on a magnitude of a required power derived from the required power deriving portion; an offset value deriving portion (for example, an offset value deriving portion 209 of the embodiment) for deriving, when an operation mode determined by the operation mode determination portion is a constant point operation mode in which the internal combustion engine is operated at a constant revolution speed, an offset value for correcting an operation point of the internal combustion engine operated in the constant point operation mode, from a degree of requirement for acceleration or deceleration by a driver of the hybrid vehicle; an internal combustion engine operation point deriving portion (for example, an internal combustion engine operation point deriving portion 211 of the embodiment) for deriving, based on the required power, a target operation point for the internal combustion engine operated in the constant point operation mode; and an internal combustion engine operation control portion (for example, an internal combustion engine operation control portion 213 of the embodiment) for controlling the internal combustion engine to operate at an operation point which is obtained by correcting the target operation point by the offset value.

Further, according to claim 2 of the invention, there is provided an internal combustion engine control apparatus, wherein the requirement for acceleration by the driver of the hybrid vehicle is brought about by the accelerator pedal operation, and when a change with time of the required power increases, the offset value deriving portion derives an offset value for increasing the revolution speed of the internal combustion engine in accordance with a change of the acceleration pedal operation.

Further, according to claim 3 of the invention, there is provided an internal combustion engine control apparatus, wherein the requirement for deceleration by the driver of the hybrid vehicle is brought about by a brake pedal operation, and when a change with time of the required power decreases, the offset value deriving portion derives an offset value for decreasing the revolution speed of the internal combustion engine in accordance with a change of the brake pedal operation.

Further, according to claim 4 of the invention, there is provided an internal combustion engine control apparatus, wherein the change rate of the accelerator pedal operation is an operation speed of the accelerator pedal of the hybrid vehicle.

Further, according to claim 5 of the invention, there is provided an internal combustion engine control apparatus, wherein the change of the brake pedal operation is an operation speed of the brake pedal of the hybrid vehicle.

Further, according to claim 6 of the invention, there is provided an internal combustion engine control apparatus, wherein the change of the accelerator pedal operation is an operation amount of the accelerator pedal of the hybrid vehicle.

Further, according to claim 7 of the invention, there is provided an internal combustion engine control apparatus, wherein the change of the brake pedal operation is an operation amount of the brake pedal of the hybrid vehicle.

Further, according to claim 8 of the invention, there is provided an internal combustion engine control apparatus, wherein the offset value deriving portion derives an offset value which changes a revolution speed of the internal combustion engine while maintaining an output efficiency of the internal combustion engine when a state of charge of the battery is equal to or higher than a predetermined level, and derives an offset value which changes a revolution speed of the internal combustion engine without changing an output of the internal combustion engine when a state of charge of the battery is lower than the predetermined level.

Further, according to claim 9 of the invention, there is provided an internal combustion engine control apparatus, wherein an effective period is set for the offset value, and the internal combustion engine operation control portion returns the operation point of the internal combustion engine to an operation point before being corrected, after a lapse of a predetermined period of time.

Further, according to claim 10 of the invention, there is provided an internal combustion engine control apparatus, wherein the effective period is variable.

Further, according to claim 11 of the invention, there is provided an internal combustion engine control apparatus, wherein when the offset value is derived for changing the revolution speed of the internal combustion engine without changing the output of the internal combustion engine, and the effective period is longer than an upper limit time, the internal combustion engine operation control portion controls the internal combustion engine so that an operation point of the internal combustion engine changes gradually to reach an operation point obtained by correcting the target operation point by the offset value.

Further, according to claim 12 of the invention, there is provided an internal combustion engine control apparatus, wherein when the offset value is derived for changing the revolution speed of the internal combustion engine while maintaining the output efficiency of the internal combustion engine, and the effective period is longer than an upper limit time, the internal combustion engine operation control portion provides an upper limit to the output of the internal combustion engine.

Further, according to claim 13 of the invention, there is provided an internal combustion engine control apparatus, wherein the upper limit time is a fixed value or a variable value which is set shorter as the vehicle speed becomes faster.

Further, according to claim 14 of the invention, there is provided an internal combustion engine control apparatus, wherein the number of times of changing the operation point until the operation point of the internal combustion engine reaches an operation point obtained by correcting the target operation point by the offset value is a fixed value or a variable value in accordance with a degree of requirement for acceleration or deceleration by the driver of the hybrid vehicle.

Further, according to claim 15 of the invention, there is provided an internal combustion engine control method for a hybrid vehicle which runs on power from an electric motor (for example, an electric motor 107 of an embodiment) which is driven by at least either of electric power generated in a generator (for example, a generator 111 of the embodiment) by power of an internal combustion engine (for example, an internal combustion engine 109) and electric power supplied from a battery (for example, a battery 101 of the embodiment), including the steps of: deriving a required power which is a power of the electric motor outputted in accordance with an accelerator pedal operation in the hybrid vehicle; deriving a power that the electric motor can output by electric power supplied from the battery; deriving an optimum power in the generator based on the required power and an attainable power of the electric motor; determining an operation mode of the internal combustion engine based on a magnitude of the optimum power in the generator; deriving, when the operation mode determined is a constant point operation mode in which the internal combustion engine is operated at a constant revolution speed, an offset value for correcting an operation point of the internal combustion engine operated in the constant point operation mode from a degree of requirement for acceleration or deceleration by the driver of the hybrid vehicle; deriving, based on the optimum power in the generator, a target operation point for the internal combustion engine operated in the constant point operation mode; and controlling the internal combustion engine to operate at an operation point which is obtained by correcting the target operation point by the offset value.

### Advantageous Effects of Invention

According to the internal combustion engine control apparatus described in claims 1 to 14 and the internal combustion engine control method described in claim 15, even when the internal combustion engine is operated in the constant point operation mode, no dissociation is produced between the acceleration or deceleration operation and the tone of operation noise of the internal combustion engine, and therefore, the driver is prevented from feeling a sense of incongruity.

According to the internal combustion engine control apparatus described in claims 2 to 7 of the invention, the way of increasing or decreasing the revolution speed of the internal combustion engine can be changed by the degree of depression of the accelerator pedal or the brake pedal which is the degree of requirement for acceleration or deceleration by the driver. The tone of operation noise of the internal combustion engine increases when the revolution speed of the internal combustion engine increases, whereas the tone of operation noise of the internal combustion engine decreases when the revolution speed of the internal combustion engine decreases.

According to the internal combustion engine control apparatus described in claim 8, the way of correcting the operation point of the internal combustion engine is changed in accordance with the state of charge of the battery. Therefore, the overcharge of the battery can be prevented by changing the revolution speed of the internal combustion engine.

According to the internal combustion engine control apparatus described in claims 9 to 10, the internal combustion engine can be released from the operation at the operation point which is corrected by the offset value by providing the effective period to the offset value.

According to the internal combustion engine control apparatus described in claim 11, the degree of deterioration of fuel consumption of the internal combustion engine can be reduced.

According to the internal combustion engine control apparatus described in claim 12, the overcharge of the battery can be prevented.

According to the internal combustion engine control apparatus described in claim 13, the degree of deterioration of fuel consumption of the internal combustion engine can be reduced.

According to the internal combustion engine control apparatus described in claim 14, the driver can feel acceleration or deceleration without feeling a sense of incongruity when he or she performs an acceleration or deceleration operation.

### BRIEF DESCRIPTION OF DRAWINGS

FIG. 1 is a block diagram showing an internal configuration of a series HEV.

FIG. 2 is a block diagram showing an internal configuration of a management ECU 119.

FIG. 3 is a flowchart showing operations performed when an internal combustion engine 109 is controlled by the management ECU 119.

FIG. 4 is a diagram showing maps made use of by the management ECU 119 when deriving parameters for controlling the internal combustion engine 109.

FIG. 5 is a flowchart showing a method for deriving an offset value for correcting a target engine torque and a target engine revolution speed of the internal combustion engine 109.

FIG. 6 is a graph showing an example of characteristics of the internal combustion engine 109 and an example of a change in operation point of the internal combustion engine 109 by offset values derived by an offset value deriving portion 209 when a required power Pr increases.

FIG. 7 is a graph showing an example of characteristics of the internal combustion engine 109 and an example of a change in operation point of the internal combustion engine 109 by offset values derived by the offset value deriving portion 209 when the required power Pr decreases.

FIG. 8 is a block diagram showing an internal configuration of a series-parallel HEV.

### DESCRIPTION OF EMBODIMENTS

Hereinafter, an embodiment of the invention will be described by reference to the drawings. In the embodiment that will be described below, an internal combustion engine control apparatus according to the invention is mounted in a series HEV (Hybrid Electric Vehicle). The series HEV includes an electric motor, an internal combustion engine and a generator and runs by making use of power of the electric motor which is driven mainly by a battery as a power supply. The internal combustion engine is used only for generating electricity, and electric power generated by the generator by the power of the internal combustion engine is supplied to the electric motor or is stored in the battery.

The series HEV performs an “EV running” or a “series running.” In the “EV running,” the HEV runs on driving force of the electric motor which is driven by power supply from the battery. In addition, in the “series running,” the HEV runs on the driving force of the electric motor which is driven by electric power supplied from both the battery and the generator or is driven by electric power supplied only from the generator.

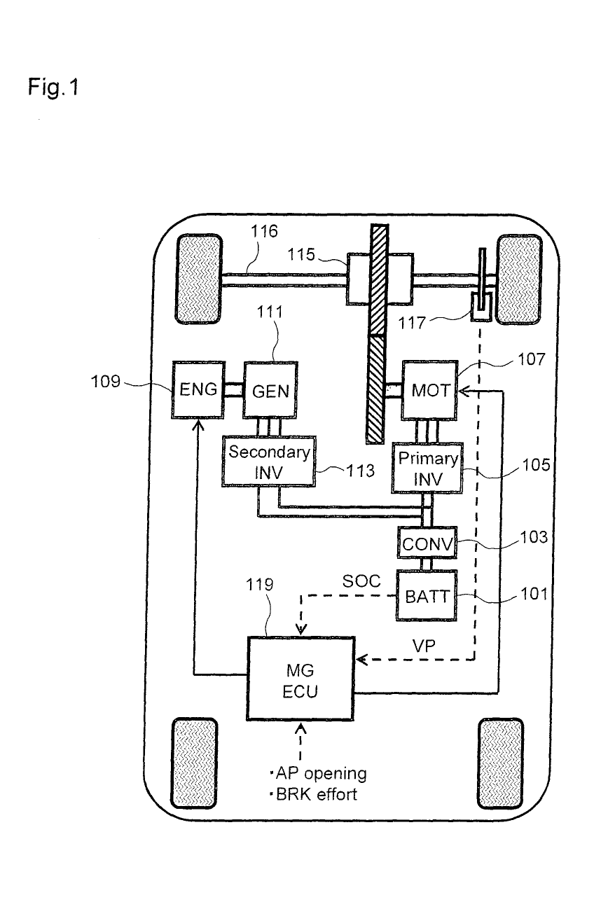

FIG. 1 is a block diagram showing an internal configuration of the series HEV. As shown in FIG. 1, the series HEV (hereinafter, referred to simply as a “vehicle”) includes a battery (BATT) 101, a converter (CONV) 103, a primary inverter (primary INV) 105, an electric motor (Mot) 107, an internal combustion engine (ENG) 109, a generator (GEN) 111, a secondary inverter (secondary INV) 113, a gearbox (hereinafter, referred to simply as a “gear”) 115, a vehicle speed sensor 117, and a management ECU (MG ECU) 119. In FIG. 1, dotted arrows denote value data, and solid arrows denote control signals which contain details of instructions.

The battery 101 has plural battery cells which are connected in series and provides a high voltage of, for example, 100 to 200 V. The battery cells are, for example, lithium ion batteries or nickel-metal hydride batteries. The converter 103 increases or decreases a direct current power voltage of the battery 101 while keeping it as direct current. The primary inverter 105 converts the direct current voltage into an alternating current voltage to supply a three-phase current to the electric motor 107. Additionally, the primary inverter 105 converts an alternating current voltage which is inputted during a regenerative operation of the electric motor 107 into a direct current to charge the battery 101.

The electric motor 107 generates power which runs the vehicle. Torque generated in the electric motor 107 is transmitted to drive shafts 116 via the gear 115. Note that a rotor of the electric motor 107 is connected directly to the gear 115. Additionally, the electric motor 107 operates as a generator while regenerative braking is applied, and electric power generated in the electric motor 107 is stored in the battery 101. The internal combustion engine 109 is used to drive the generator 111 when the vehicle series runs. The internal combustion engine 109 is connected directly to a rotor of the generator 111.

The generator 111 is driven by the power of the internal combustion engine 109 and generates electric power. Electric power generated by the generator 111 is stored in the battery 101 or is supplied to the electric motor 107. The secondary inverter 113 converts an alternating current voltage generated by the generator 111 into a direct current voltage. Electric power converted by the second inverter 113 is stored in the battery 101 or is supplied to the electric motor 107 via the primary inverter 105.

The gear 115 is a single stage fixed gear which corresponds to a fifth speed, for example. Consequently, the gear 115 converts driving force from the electric motor 107 into revolution speed and torque at a specific gear ratio for transmission to the drive shafts 116. The vehicle speed sensor 117 detects a running speed (a vehicle speed VP) of the vehicle. A signal signaling the vehicle speed VP detected by the vehicle sensor 117 is sent to the management ECU 119. Note that the revolution speed of the electric motor 107 may be used in place of the vehicle speed VP.

The management ECU 119 obtains pieces of information indicating the vehicle speed VP, a state of charge (SOC) which indicates a state of the battery 101, an accelerator pedal opening (AP opening) in accordance with an acceleration pedal operation by the driver, and a brake pedal effort (BRK effort) in accordance with a brake pedal operation by the driver and controls individually the electric motor 107 and the internal combustion engine 109. The details of the management ECU 119 will be described later. The operation mode of the internal combustion engine 109 through control by the management ECU 119 includes a constant point operation mode and a power-follow operation mode. When operated in the constant point mode, the internal combustion engine 109 is operated at a constant revolution speed which provides the best fuel consumption. On the other hand, when operated in the power-follow operation mode, the internal combustion engine 109 is operated at a required revolution speed in accordance with a power requirement.

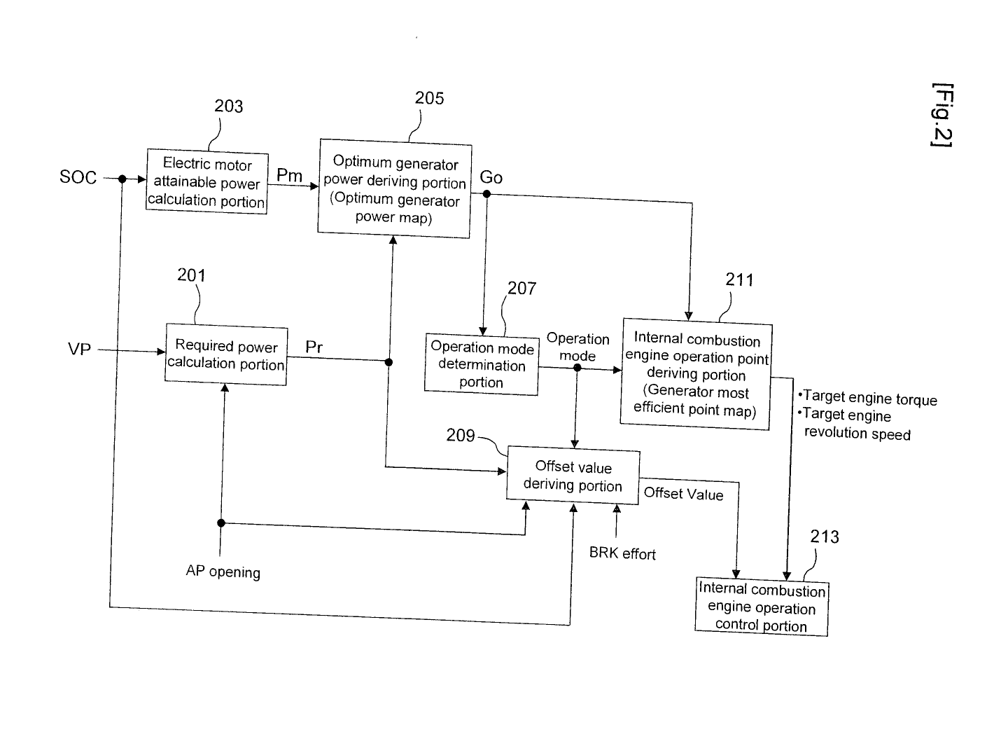

FIG. 2 is a block diagram showing an internal configuration of the management ECU 119. As shown in FIG. 2, the management ECU 119 has a required power calculation portion 201, an electric motor attainable power calculation portion 203, an optimum generator power deriving portion 205, an operation mode determination portion 207, an offset value deriving portion 209, an internal combustion engine operation point deriving portion 211 and an internal combustion engine operation control portion 213.

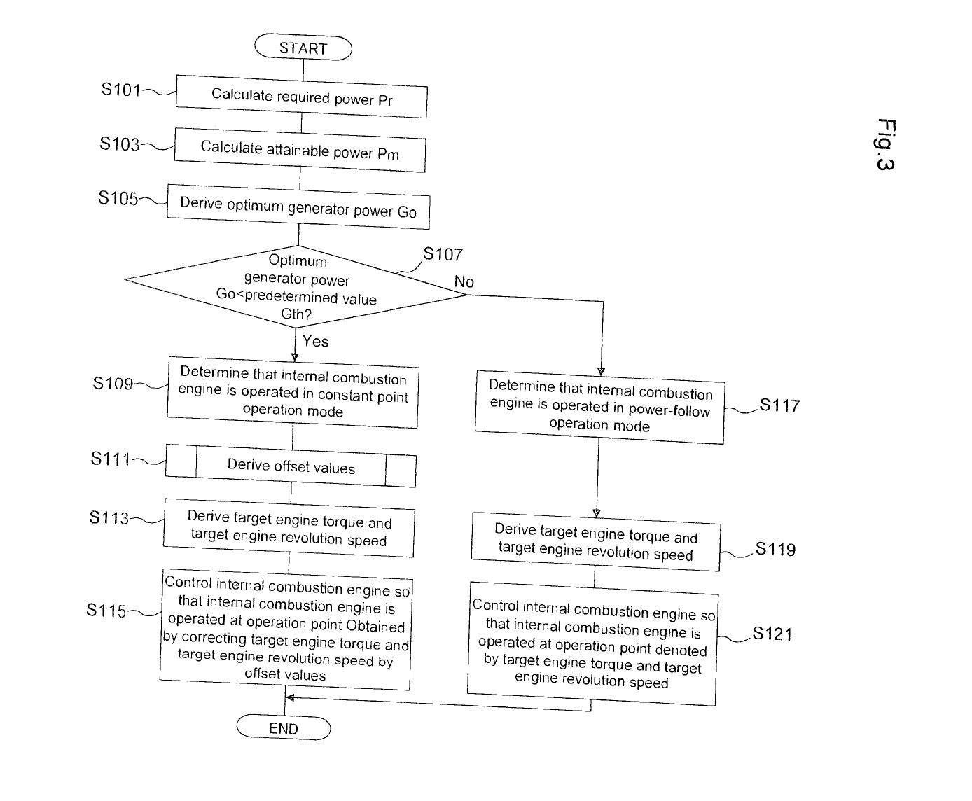

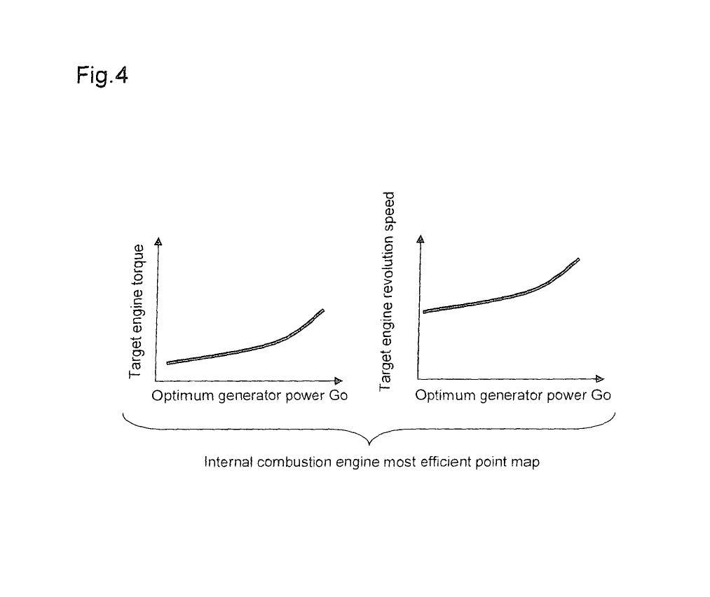

Hereinafter, respective operations of the constituent elements of the management ECU 119 and a method for deriving parameters (target engine torque and target engine revolution speed) for controlling the internal combustion engine 109 by the management ECU 119 will be described by reference to FIG. 2 and FIGS. 3 to 7. FIG. 3 is a flowchart showing operations performed when the internal combustion engine 109 is controlled by the management ECU 119. FIG. 4 is a diagram showing maps made use of by the management ECU 119 when deriving parameters for controlling the internal combustion engine 109. These maps are stored in an interior of the management ECU 119 or in an exterior memory which can be accessed by the management ECU 119.

As shown in FIG. 3, the required power calculation portion 201 calculates power required of the electric motor 107 (hereinafter, referred to as “required power”) Pr based on an AP opening and a vehicle speed VP (step S101). Following this, the electric motor attainable power calculation portion 203 calculates a maximum power that the electric motor 107 can output by electric power supplied from the battery 101 (hereinafter, referred to as “attainable power”) Pm based on an SOC of the battery 101 (step S103). Following this, the optimum generator power deriving portion 205 derives an optimum power of the generator 111 (hereinafter, referred to as an “optimum generator power”) Go based on the required power Pr and the attainable power Pm (step S105).

Next, the operation mode determination portion 207 compares the optimum generator power Go derived in step S105 by the optimum generator power deriving portion 205 with a predetermined value Gth to examine a magnitude relation therebetween (step S107). If it is determined based on the result of the comparison executed in step S107 that the optimum generator power Go is smaller than the predetermined value Gth (Go<Gth), the flow proceeds to step S109, and the operation mode determination portion 211 determines that the internal combustion engine 109 is to be operated in the constant point operation mode. On the other hand, if it is determined that the optimum generator power Go is equal to or larger than the predetermined value Gth (Go>=Gth), the flow proceeds to step S117, and the operation mode determination portion 211 determines that the internal combustion engine 109 is to be operated in the power-follow operation mode.

After step S109, the offset value deriving portion 209 derives an offset value for correcting a target torque (a target engine torque) and a target revolution speed (a target engine revolution speed) of the internal combustion engine 109 which is operated in the constant point operation mode (step S111). An offset value deriving method executed by the offset value deriving portion 209 in step S111 will be described in detail later.

After step S111, the internal combustion engine operation point deriving portion 211 derives a target torque (a target engine torque) for the internal combustion engine 109 which operates in the constant mode operation mode based on the optimum generator power Go which is derived from the optimum generator power deriving portion 205 in step S105 (step S113). The internal combustion engine operation control portion 213 controls the internal combustion engine 109 to operate at an operation point obtained by correcting the target engine torque and the target engine revolution speed which are derived in step S113 by the offset value derived in step S111 (step S115).

On the other hand, after step S117, the internal combustion engine operation point deriving portion 211 derives a target torque (a target engine torque) and a target revolution speed (a target engine revolution speed) for the internal combustion engine 109 which operates the power-follow operation mode based on the optimum generator power Go derived in step S105 by the optimum generator power deriving portion 205 and internal combustion engine most efficient point maps shown in FIG. 4 (step S119). The internal combustion engine operation control portion 213 controls the internal combustion engine 109 to operate at an operation point which is indicated by the target engine torque and the target engine revolution speed which are derived in step S119 (step S121).

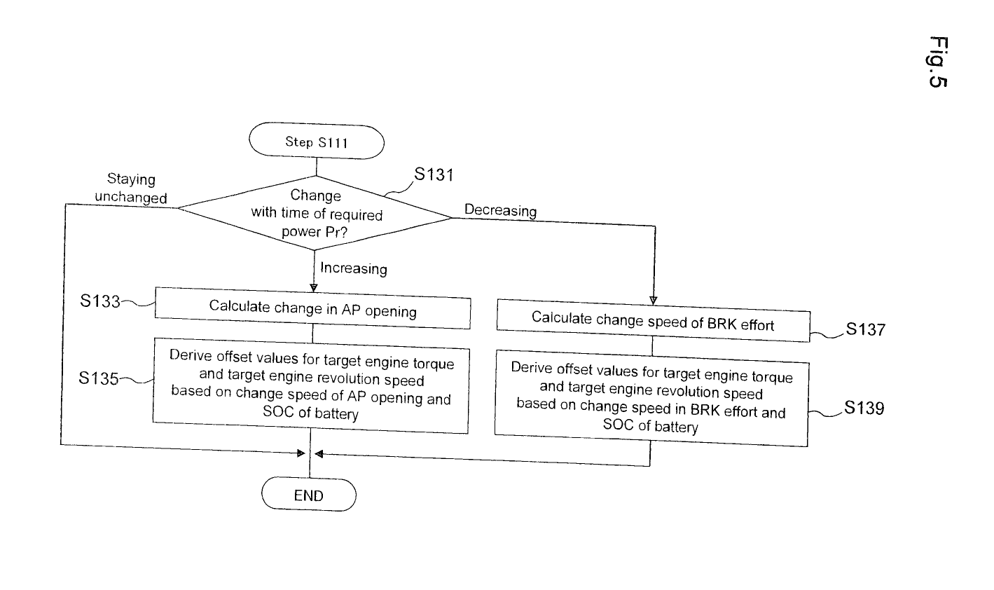

Hereinafter, the method for deriving an offset value which is executed in step S111 by the offset value deriving portion 209 will be described in detail by reference to FIG. 5. FIG. 5 is a flowchart showing the method for deriving an offset value for correcting the target engine torque and the target engine revolution speed of the internal combustion engine 109. As shown in FIG. 5, the offset value deriving portion 209 determines whether the required power Pr calculated in step S101 is increasing, decreasing or is staying unchanged (step S131).

If it is determined based on the result of the determination executed in step S131 that the required power Pr is “staying unchanged,” the offset value deriving portion 209 does not derive an offset value and ends step S111. In addition, if it is determined based on the result of the determination executed in step S131 that the required power Pr is “increasing,” the flow proceeds to step S133, where the offset value deriving portion 209 derives a change in speed of the AP opening which indicates the degree of requirement for acceleration by the driver. In step S133, the offset value deriving portion 209 may derive a change in amount of the AP opening within a predetermined period of time in place of the change in speed of the AP opening. Additionally, if it is determined based on the result of the determination executed in step S131 that the required power Pr is “decreasing,” the flow proceeds to step S137, where the offset value deriving portion 209 derives a change in speed of the BRK effort which indicates the degree of requirement for deceleration by the driver. In step S137, the offset value deriving portion 209 may derive a change in amount of the BRK effort within a predetermined period of time in place of the change in speed of the BRK effort.

After step S133, the offset value deriving portion 209 derives offset values for the target engine toque and the target engine revolution speed based on the change in speed or change in amount of the AP opening which is calculated in step S133 and the SOC of the battery 101 (step S135). Additionally, after step S137, the offset value deriving portion 209 derives offset values for the target engine torque and the target engine speed based on the change in speed or change in amount of the BRK effort and the SOC of the battery 101 (step S139).

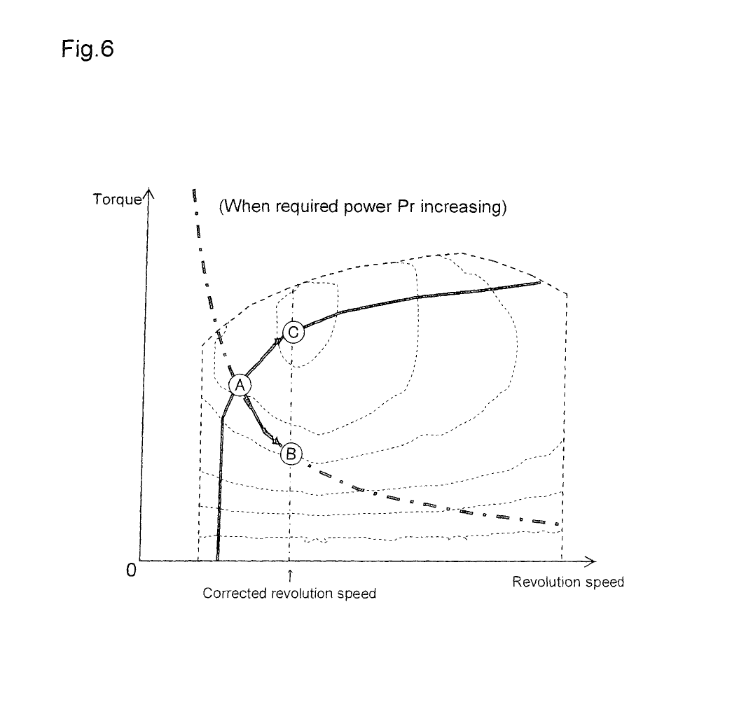

FIG. 6 is a graph showing an example of characteristics of the internal combustion engine 109 and an example of a change in operation point of the internal combustion engine 109 by the offset values derived from the offset value deriving portion 209 when the required power Pr is increasing. In the graph, an axis of ordinate denotes the torque of the internal combustion engine 109, and an axis of abscissa denotes the revolution speed of the internal combustion engine 109. In FIG. 6, a thick solid line denotes a line which connects operation points of the engine where the fuel consumption rate becomes the best (hereinafter, referred to as a “BSFC bottom line”). When driven in the constant point operation mode, the internal combustion engine 109 is operated at an operation point denoted by reference character A on the line. Additionally, in FIG. 6, a thick alternate long and short dash line denotes a line which connects operation points of the internal combustion engine 109 where the power becomes equal although the torque and engine revolution speed are different (hereinafter, referred to as an “equal power line”).

The offset values derived in step S135 are values for increasing the revolution speed of the internal combustion engine 109. In this embodiment, when the SOC of the battery 101 is equal to or larger than a predetermined value SOCth, the offset value deriving portion 209 derives offset values which increase the revolution speed of the internal combustion engine 109 without changing the power produced therefrom in step S135. The internal combustion engine 109 is operated at an operation point denoted by reference character B in FIG. 6 by the target engine torque and the target engine revolution speed being corrected by the offset values. The tone of operation noise of the internal combustion engine 109 is increased when the revolution speed of the internal combustion engine 109 increases.

On the other hand, when the SOC of the battery 101 is smaller than the predetermined value SOCth, the offset value deriving portion 209 derives offset values which increase the revolution speed while holding the power output efficiency of the internal combustion engine 109 in step S135. The internal combustion engine 109 is operated at an operation point denoted by reference character C in FIG. 6 by the target engine torque and the target engine revolution speed being corrected by the offset values. The increase in revolution speed of the internal combustion engine 109 by the offset values is proportional to the change in speed or change in amount of the AP opening irrespective of the magnitude relation between the SOC of the battery 101 and the predetermined value SOCth. In addition, the increasing speed of revolution speed of the internal combustion engine 109 is also proportional to the change in speed or change in amount of the AP opening.

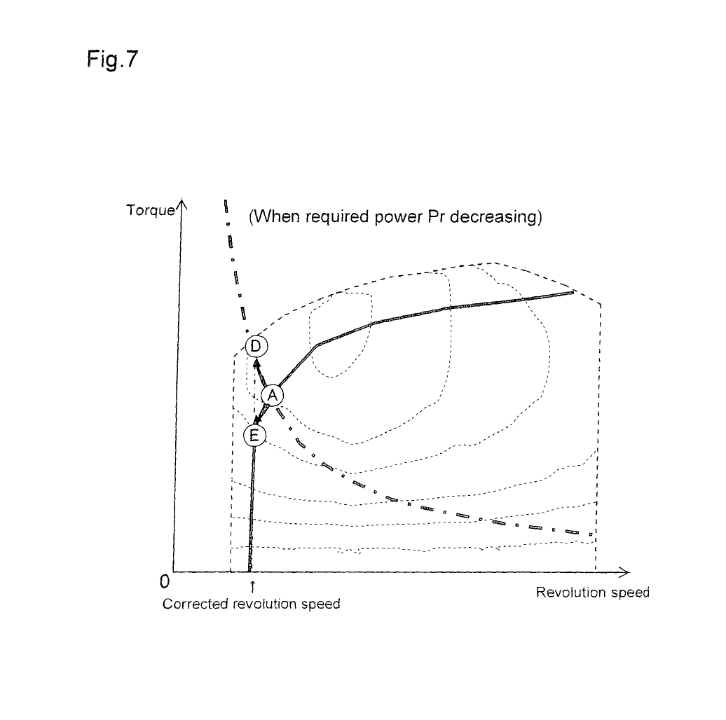

FIG. 7 is a graph showing an example of characteristics of the internal combustion engine 109 and an example of a change in operation point of the internal combustion engine 109 by offset values derived from the offset value deriving portion 209 when the required power Pr decreases. In the graph, an axis of ordinate denotes the torque of the internal combustion engine 109, and an axis of abscissa denotes the revolution speed of the internal combustion engine 109. In FIG. 7, a thick solid line denotes a BSFC bottom line. Additionally, in FIG. 7, a thick alternate long and short dash line denotes an equal power line.

The offset values derived in step S139 are values for decreasing the revolution speed of the internal combustion engine 109. In this embodiment, the offset value deriving portion 209 derives offset values which decrease the revolution speed of the internal combustion engine 109 without changing the power produced therefrom in step S139. The tone of operation noise of the internal combustion engine 109 is lowered when the revolution speed of the internal combustion engine 109 decreases.

The decrease in revolution speed of the internal combustion engine 109 by the offset values is proportional to the change in speed or change in amount of the BRK effort irrespective of the magnitude relation between the SOC of the battery 101 and the predetermined value SOCth. In addition, the decreasing speed of revolution speed of the internal combustion engine 109 is also proportional to the change in speed or change in amount of the BRK effort. In step S139, when the SOC of the battery 101 is equal to or larger than the predetermined value SOCth, the internal combustion engine 109 is operated at an operation point where the power output efficiency is good because it is not necessary to force the battery 101 being charged. Therefore, the operation point of the internal combustion engine 109 is shifted from reference character A to reference character E along the BSFC bottom line in order that the internal combustion engine 109 is operated at the operation point, where the power output efficiency is good, denoted by reference character E in FIG. 7. On the other hand, when the SOC of the battery 101 is smaller than the predetermined value SOCth, the internal combustion engine 109 is operated in order to charge the battery 101 rather than the power output efficiency. Therefore, the operation point of the internal combustion engine 109 is shifted from reference character A to reference character D along the equal power line in order that the internal combustion engine 109 is operated at the operation point, where greater torque is obtained, denoted by reference character D in FIG. 7.

An effective period is set to the outset values which are derived from the offset value deriving portion 209 that has been described above. Namely, even in the event that the revolution of speed of the internal combustion engine 109 is increased or decreased by the offset values, the internal combustion engine operation control portion 213 returns the operation point of the internal combustion engine 109 to the operation point before the correction is made after a lapse of a predetermined period of time. In addition, the offset value deriving portion 209 may change the effective period that is set to the offset values in accordance with the depression speed of the accelerator pedal or the brake pedal, the vehicle speed, the current SOC of the battery 101 or catalyst temperatures.

For example, in the case of the effective period being changed in accordance with the depression speed of the accelerator pedal, the offset value deriving portion 209 extends the effective period when the depression speed is fast, whereas the offset value deriving portion 209 shortens the effective period when the depression speed is slow. It is considered that a fast depression speed of the accelerator pedal indicates that the driver seriously requires acceleration, and therefore, high-tone operation noise of the internal combustion engine 109 can be produced longer than the normal period of time during which the high-tone operation noise is produced.

Additionally, in the case of the effective period being changed in accordance with the vehicle speed, the offset value deriving portion 209 shortens the effective period when the vehicle speed belongs to a high-speed region, whereas the offset value deriving portion 209 extends the effective period when the vehicle speed belongs to a low-speed region. When the power is increased in a high vehicle speed region, a state continues in which the power produced remains close to a limit value that the vehicle can produce, and therefore, there are fears that the battery 101 becomes flat. Then, by changing the effective period in the way described above, the potential of the vehicle thereafter can be maintained.

In addition, in the case of the effective period being changed in accordance with catalyst temperatures, the offset value deriving portion 209 extends the effective period when the catalyst temperature is high, whereas when the catalyst temperature is low, the offset deriving portion 209 shortens the effective period. By changing the effective period in the way described above, the amount of emission of carbon dioxide can be reduced.

Additionally, the fuel consumption is deteriorated when the effective period of the offset values long which change the revolution speed of the internal combustion engine 109 while holding the power produced therefrom. Because of this, the internal combustion engine operation control portion 213 changes gradually the operation point of the internal combustion engine 109 to the target engine revolution speed when the effective period which is set to the offset values is longer than an upper limit time which is set in advance. Additionally, in the case of the offset values which change the revolution speed while holding the power output efficiency, the internal combustion engine operation control portion 213 may set an upper limit to the power produced by the internal combustion engine 109. In this case, the overcharge of the battery 101 can be prevented.

Although the upper limit time may be a fixed value, the upper limit time may be a variable value. For example, when the upper limit time is made shorter as the vehicle speed increases higher, the upper limit of power can be set low. Because of this, the degree of deterioration of fuel consumption in the internal combustion engine 109 can be lowered. In addition, although the number of times of changing the operation point until the operation point of the internal combustion engine 109 is changed gradually to the target engine revolution speed may be a fixed value, the number of times of changing the operation point may be a variable value which varies in accordance with the depression amount of the accelerator pedal or the brake pedal. For example, in the event that the number of times of power output increases as the depression amount increases, the driver can feel acceleration or deceleration without having to feel a sense of incongruity when he or she performs an acceleration or deceleration operation.

Thus, as has been described heretofore, according to the embodiment, the tone of operation noise of the internal combustion engine 109 changes in accordance with the operation of the accelerator pedal or the brake pedal by the driver even when the internal combustion engine 109 is operated at the constant point. Because of this, the driver can drive the vehicle without having to feel a sense of incongruity. Additionally, the way of correcting the operation point of the internal combustion engine 109 is changed in accordance with the SOC of the battery 101, and therefore, the overcharge of the battery 101 can be prevented which would otherwise be caused by increasing the revolution speed of the internal combustion engine 109.

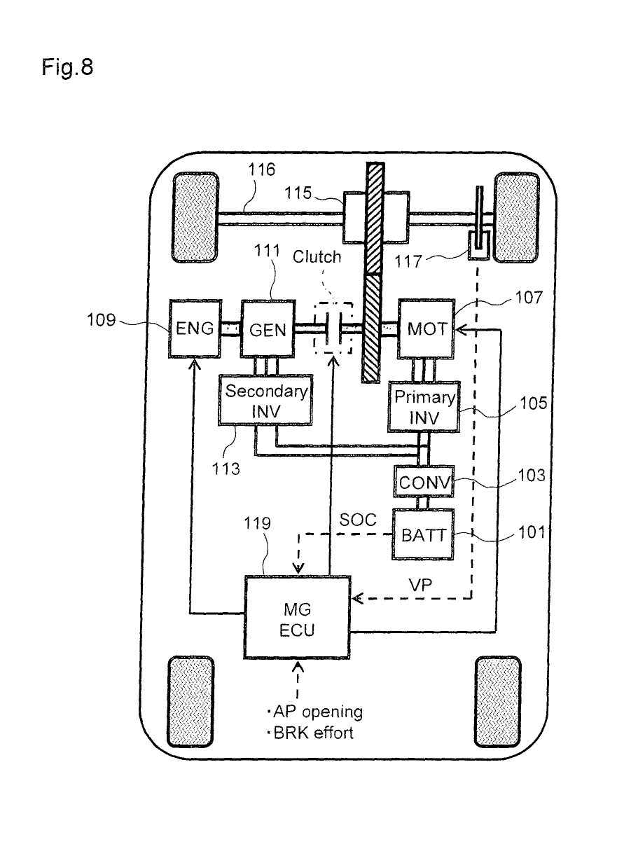

While the embodiment has been described by taking the series HEV as an example, the invention can also be applied to a series-parallel HEV shown in FIG. 8.

### REFERENCE SIGNS LIST

101 Battery (BATT)
103 Converter (CONV)
105 Primary inverter (Primary INV)
107 Electric motor (MOT)
109 Internal combustion engine (ENG)
111 Generator (GEN)
113 Secondary inverter (Secondary INV)
115 Gearbox
116 Drive shaft
117 Vehicle speed sensor
119 Management ECU (MG ECU)
201 required power calculation portion
203 Electric motor attainable power calculation portion
205 Optimum generator power deriving portion
207 Operation mode determination portion
209 Offset value deriving portion
211 Internal combustion engine operation point deriving portion
213 Internal combustion engine operation control portion

1. An internal combustion engine control apparatus for a hybrid vehicle which runs on power from an electric motor which is driven by at least either of electric power generated in a generator by power of an internal combustion engine and electric power supplied from a battery, comprising:
a required power deriving portion for deriving a required power which is a power of the electric motor outputted in accordance with an accelerator pedal operation in the hybrid vehicle;
an operation mode determination portion for determining an operation mode of the internal combustion engine based on a magnitude of a required power derived from the required power deriving portion;
an offset value deriving portion for deriving, when an operation mode determined by the operation mode determination portion is a constant point operation mode in which the internal combustion engine is operated at a constant revolution speed, an offset value for correcting an operation point of the internal combustion engine operated in the constant point operation mode, from a degree of requirement for acceleration or deceleration by a driver of the hybrid vehicle;
an internal combustion engine operation point deriving portion for deriving, based on the required power, a target operation point for the internal combustion engine operated in the constant point operation mode; and
an internal combustion engine operation control portion for controlling the internal combustion engine to operate at an operation point which is obtained by correcting the target operation point by the offset value.

2. The internal combustion engine control apparatus according to claim 1,
wherein the requirement for acceleration by the driver of the hybrid vehicle is brought about by the accelerator pedal operation, and
when a change with time of the required power increases, the offset value deriving portion derives an offset value for increasing the revolution speed of the internal combustion engine in accordance with a change of the acceleration pedal operation.

3. The internal combustion engine control apparatus according to claim 1,
wherein the requirement for deceleration by the driver of the hybrid vehicle is brought about by a brake pedal operation, and
when a change with time of the required power decreases, the offset value deriving portion derives an offset value for decreasing the revolution speed of the internal combustion engine in accordance with a change of the brake pedal operation.

4. The internal combustion engine control apparatus according to claim 2,
wherein the change of the accelerator pedal operation is an operation speed of the accelerator pedal of the hybrid vehicle.

5. The internal combustion engine control apparatus according to claim 3,
wherein the change of the brake pedal operation is an operation speed of the brake pedal of the hybrid vehicle.

6. The internal combustion engine control apparatus according to claim 2,
wherein the change of the accelerator pedal operation is an operation amount of the accelerator pedal of the hybrid vehicle.

7. The internal combustion engine control apparatus according to claim 3,
wherein the change of the brake pedal operation is an operation amount of the brake pedal of the hybrid vehicle.

8. The internal combustion engine control apparatus according to claim 2,
wherein the offset value deriving portion derives an offset value which changes a revolution speed of the internal combustion engine while maintaining an output efficiency of the internal combustion engine when a state of charge of the battery is equal to or higher than a predetermined level, and derives an offset value which changes a revolution speed of the internal combustion engine without changing an output of the internal combustion engine when a state of charge of the battery is lower than the predetermined level.

9. The internal combustion engine control apparatus according to claim 1,
wherein an effective period is set for the offset value, and
the internal combustion engine operation control portion returns the operation point of the internal combustion engine to an operation point before being corrected, after a lapse of a predetermined period of time.

10. The internal combustion engine control apparatus according to claim 9,
wherein the effective period is variable.

11. The internal combustion engine control apparatus according to claim 9,
wherein when the offset value is derived for changing the revolution speed of the internal combustion engine without changing the output of the internal combustion engine, and the effective period is longer than an upper limit time, the internal combustion engine operation control portion controls the internal combustion engine so that an operation point of the internal combustion engine changes gradually to reach an operation point obtained by correcting the target operation point by the offset value.

12. The internal combustion engine control apparatus according to claim 9,
wherein when the offset value is derived for changing the revolution speed of the internal combustion engine while maintaining the output efficiency of the internal combustion engine, and the effective period is longer than an upper limit time, the internal combustion engine operation control portion provides an upper limit to the output of the internal combustion engine.

13. The internal combustion engine control apparatus according to claim 11,
wherein the upper limit time is a fixed value or a variable value which is set shorter as the vehicle speed becomes faster.

14. The internal combustion engine control apparatus according to claim 11,
wherein the number of times of changing the operation point until the operation point of the internal combustion engine reaches an operation point obtained by correcting the target operation point by the offset value is a fixed value or a variable value in accordance with a degree of requirement for acceleration or deceleration by the driver of the hybrid vehicle.

15. An internal combustion engine control method for a hybrid vehicle which runs on power from an electric motor which is driven by at least either of electric power generated in a generator by power of an internal combustion engine and electric power supplied from a battery, comprising the steps of:
deriving a required power which is a power of the electric motor outputted in accordance with an accelerator pedal operation in the hybrid vehicle;
deriving a power that the electric motor can output by electric power supplied from the battery;
deriving an optimum power in the generator based on the required power and an attainable power of the electric motor;
determining an operation mode of the internal combustion engine based on a magnitude of the optimum power in the generator;
deriving, when the operation mode determined is a constant point operation mode in which the internal combustion engine is operated at a constant revolution speed, an offset value for correcting an operation point of the internal combustion engine operated in the constant point operation mode, from a degree of requirement for acceleration or deceleration by a driver of the hybrid vehicle;
deriving, based on the optimum power in the generator, a target operation point for the internal combustion engine operated in the constant point operation mode; and
controlling the internal combustion engine to operate at an operation point which is obtained by correcting the target operation point by the offset value.
